(19) United States
(12) Patent Application Publication
(10) Pub. No.: US 2007/0082159 A1
(43) Pub. Date: Apr. 12, 2007

(54) Themoplastic material comprising nanometric lamellar compounds

(76) Inventors: Olivier Mathieu, Marennes (FR); Bruno Echalier, Paris (FR); Bertrand Lousteau, Paris (FR)

Correspondence Address: Jean-Louis Seugnet;Rhodia Inc, Intellectual Property Dept, 259 Prospect Palins Road CN 7500, Cranbury, NJ, 08512-7500, US

(21) Appl. No.: 10/554,971

(22) PCT Filed: Apr. 27, 2004
(86) PCT No.: PCT/FR04/01013

§ 371 Date: Oct. 27, 2006

(30) Foreign Application Priority Data
Apr. 28, 2003 (FR) 03/05165

(51) Int. Cl. B29C 47/00

(52) U.S. Cl. 428/36.9

(57) ABSTRACT

The invention relates to materials comprising a thermoplastic matrix and at least particles based on phosphate of zirconium, titanium, cerium and/or silicon in the form of nanometric lamellar compounds having a shape factor of less than 100. The aforementioned materials can be used, for example, for the production of plastic parts, such as films, sheets, tubes, hollow or solid bodies, bottles, conduits or tanks.

The present invention relates to materials comprising a thermoplastic matrix and at least particles based on zirconium, titanium, cerium and/or silicon phosphate in the form of nanometric lamellar compounds exhibiting an aspect ratio of less than 100. These materials can in particular be used for the manufacture of plastic components, such as, for example, films, sheets, pipes, hollow or solid bodies, bottles, conduits or tanks.

### PRIOR ART

It is known from the prior art to use fillers to modify certain properties of thermoplastic matrices, such as, in particular, the barrier properties to gases or to liquids or the mechanical properties.

To reduce the permeability, it is possible in particular to add lamellar nanofillers to the thermoplastic matrix. Such a reduction in permeability is attributed to an effect of “tortuousness” brought about by the lamellar nanofillers. This is because the gases or the liquids have to follow a much longer pathway because of these obstacles arranged in successive strata. Theoretical models regard the barrier effects as becoming more pronounced as the aspect ratio, that is to say the length/thickness ratio, increases.

The lamellar nanofillers which are most widely investigated today are clays of smectite type, mainly montmorillonite. The difficulty of use lies first of all in the more or less extensive separation of these individual lamellae, that is to say the exfoliation, and in their distribution, in the polymer. To help in the exfoliation, use is made of an “intercalation” technique, which consists in swelling the crystals with organic cations, generally quaternary ammonium cations, which will compensate for the negative charge of the lamellae. These crystalline aluminosilicates, when they are exfoliated in a thermoplastic matrix, exist in the form of individual lamellae, the aspect ratio of which reaches values of the order of 500 or more.

Thus, to date, provision has been made in the prior art to use lamellar nanofillers in their exfoliated forms in the final matrix to enhance the barrier properties of the materials. However, the intercalation treatment is expensive and the dispersions obtained are difficult to employ in thermoplastic matrices.

It is thus desirable to develop fillers which make it possible to obtain effective levels of impermeability for thermoplastic matrices while avoiding the abovementioned disadvantages.

Alternatively, to enhance the mechanical properties of thermoplastic matrices, fillers, such as glass fibers or talc, for example, can be added. However, the addition of fillers of this type in significant proportions to obtain required mechanical properties increases the densities of the materials obtained.

There thus exists a need to demonstrate fillers which can be added in a small amount to the matrices while retaining a correct level with regard to the mechanical properties.

### THE INVENTION

The Applicant Company has demonstrated, in an entirely surprising way, that materials based on a thermoplastic matrix comprising particles based on zirconium, titanium, cerium and/or silicon phosphate, in the form of nonexfoliated nanometric lamellar compounds, exhibit good barrier properties to liquids and to gases and/or good mechanical properties, such as, for example, a good modulus/impact compromise, and/or a temperature stability which allows it to be handled and used at high temperatures.

The particles according to the present invention are present in the thermoplastic matrix in the form of nanometric lamellar compounds, that is to say in the form of a stack of several lamellae.

The use of a nanometric lamellar compound in a thermoplastic matrix exhibits the advantage of weakly modifying the rheology of said thermoplastic matrix. The thermoplastic compositions obtained thus have fluidity and mechanical qualities required in the industry for the conversion of these polymers.

The term “composition possessing barrier properties to gases and liquids” is understood to mean a composition which exhibits a reduced permeability with regard to a fluid. According to the present invention, the fluid can be a gas or a liquid. Mention may in particular be made, among the gases to which the composition exhibits a low permeability, of oxygen, carbon dioxide and water vapor. Mention may be made, as liquids to which the composition is impermeable, of nonpolar solvents, in particular the representative solvents of gasolines, such as toluene or isooctane, and/or polar solvents, such as water and alcohols.

### DETAILED ACCOUNT OF THE INVENTION

The present invention relates to a composition comprising at least one thermoplastic matrix and particles based on zirconium, titanium, cerium and/or silicon phosphate, in which composition at least 50% by number of the particles are in the form of nanometric lamellar compounds exhibiting an aspect ratio of less than or equal to 100.

The term “nanometric lamellar compound” is understood to mean a stack of several lamellae exhibiting a thickness of the order of several nanometers.

The nanometric lamellar compound according to the invention can be nonintercalated or else intercalated by an intercalation agent, also referred to as swelling agent.

The term “aspect ratio” is understood to mean the ratio of the greatest dimension, generally the length, to the thickness of the nanometric lamellar compound. Preferably, the particles of nanometric lamellar compounds exhibit an aspect ratio of less than or equal to 50, more preferably of less than or equal to 10, particularly of less than or equal to 5. Preferably, the particles of nanometric lamellar compounds exhibit an aspect ratio of greater than or equal to 1.

The term “a nanometric compound”, within the meaning of the present invention, is understood to mean a compound having a dimension of less than 1 μm. Generally, the particles of nanometric lamellar compounds of the invention exhibit a length of between 50 and 900 nm, preferably between 100 and 600 nm, a width of between 100 and 500 nm and a thickness of between 50 and 200 nm (the length representing the longest dimension). The various dimensions of the nanometric lamellar compound can be measured by transmission electron microscopy (TEM) or scanning electron microscopy (SEM).

Generally, the distance between the lamellae of the nanometric lamellar compound is between 5 and 15 Å, preferably between 7 and 10 Å. This distance between the lamellae can be measured by crystallographic analytical techniques, such as, for example, X-ray diffraction.

According to the present invention, 50% by number of the particles are in the form of nanometric lamellar compounds exhibiting an aspect ratio of less than or equal to 100. The other particles can be in particular in the form of individual lamellae, for example obtained by exfoliation of a nanometric lamellar compound.

Preferably, at least 80% by number of the particles are in the form of nanometric lamellar compounds exhibiting an aspect ratio of less than or equal to 100. More preferably, approximately 100% by number of the particles are in the form of nanometric lamellar compounds exhibiting an aspect ratio of less than or equal to 100.

The particles according to the invention can optionally be gathered together in the form of aggregates and/or agglomerates in the thermoplastic matrix. These aggregates and/or agglomerates can in particular exhibit a dimension of greater than one micron.

Use may also be made, for the present invention, of particles of hydrated nanometric lamellar compounds based on zirconium, titanium, cerium and/or silicon phosphate, such as, for example, monohydrated or dihydrated compounds.

Use is preferably made, according to the present invention, of zirconium phosphate, such as a ZrP of formula Zr(HPO₄)₂ or γZrP of formula Zr(H₂PO₄)₂(HPO₄).

It is also possible, according to the invention, to treat the particles based on zirconium, titanium, cerium and/or silicon phosphate with an organic compound before introduction into the thermoplastic matrix, in particular with an aminosilane compound, such as, for example, 3-aminopropyltriethoxysilane, or an alkylamine compound, such as, for example, pentylamine.

The composition according to the invention can comprise from 0.01 to 30% by weight of particles according to the invention with respect to the total weight of the composition, preferably less than 10% by weight, more preferably from 0.1 to 10% by weight, more preferably still from 0.1 to 5% by weight, particularly from 0.3 to 3% by weight, very particularly from 1 to 3% by weight.

The composition of the invention comprises, as main constituent, a thermoplastic matrix comprising at least one thermoplastic polymer. The thermoplastic polymers are preferably chosen from the group consisting of: polyamides, polyesters, polyolefins and poly(arylene oxide)s, and the blends and copolymers based on these (co) polymers.

Mention may be made, as preferred polymers of the invention, of semicrystalline or amorphous polyamides and copolyamides, such as aliphatic polyamides, semiaromatic polyamides and more generally linear polyamides obtained by polycondensation between a saturated aliphatic or aromatic diacid and a saturated aliphatic or aromatic primary diamine, polyamides obtained by condensation of a lactam or of an amino acid, or linear polyamides obtained by condensation of a mixture of these various monomers. More specifically, these copolyamides can, for example, be poly(hexamethylene adipamide), polyphthalamides obtained from terephthalic and/or isophthalic acid, or copolyamides obtained from adipic acid, from hexamethylene diamine and from caprolactam. According to a preferred embodiment of the invention, the thermoplastic matrix is a polyamide chosen from the group consisting of polyamide 6, polyamide 66, polyamide 11, polyamide 12 and poly(meta-xylylenediamine) (MXD6), and the blends and copolymers based on these polyamides.

Mention may also be made, as other polymeric material, of polyolefins, such as polyethylene, polypropylene, polyisobutylene or polymethylpentene, and their blends and/or copolymers. Preference is given in particular to polypropylene, which can be of atactic, syndiotactic or isotactic type. The polypropylene can be obtained in particular by polymerization of propylene with optionally ethylene, so as to obtain a polypropylene copolymer. Use is preferably made of the isotactic polypropylene homopolymer.

The composition according to the invention can, in addition, optionally comprise particles of nanometric lamellar compound comprising an intercalation agent which is intercalated between the lamellae of the particles and/or an exfoliation agent which is capable of exfoliating the lamellae of the particles, so as to completely separate the lamellae from one another in order to obtain individual lamellae. These particles can be nanometric lamellar compounds based on zirconium, titanium, cerium and/or silicon phosphate or any other type of compound, such as: natural or synthetic clays of the smectite type, such as, for example, montmorillonites, laponites, lucentiles or saponites, lamellar silicas, lamellar hydroxides, acicular phosphates, hydrotalcites, apatites and zeolitic polymers.

The intercalation and/or exfoliation agents can be chosen from the group consisting of: NaOH, KOH, LiOH, NH₃, monoamines, such as n-butylamine, diamines, such as hexamethylenediamine or 2-methylpentamethylenediamine, amino acids, such as aminocaproic acid and aminoundecanoic acid, and amino alcohols, such as triethanolamine.

The composition of the invention can also comprise other additives generally used in compositions based on a thermoplastic matrix, such as, for example: stabilizers, nucleating agents, plasticizers, flame retardants, stabilizers, for example of the HALS type, antioxidants, UV stabilizers, colorants, optical brighteners, lubricants, antiblocking agents, mattifying agents, such as titanium oxide, processing aids, elastomers or elastomeric compositions, for example ethylene-propylene copolymers optionally functionalized by grafting (maleic anhydride, glycidyl), copolymers of olefin and of acrylics or copolymers of methacrylate, of butadiene and of styrene, adhesion promoters, for example polyolefins grafted with maleic anhydride, making possible adhesion to polyamide, dispersing agents, scavengers or absorbers of active oxygen, and/or catalysts.

The composition of the invention can also comprise inorganic reinforcing additives, such as aluminosilicate clays (intercalated or nonintercalated and exfoliated or nonexfoliated), kaolins, talcs, calcium carbonates, fluoromicas, calcium phosphates and derivatives, or fibrous reinforcements, such as glass fibers, aramid fibers and carbon fibers.

Any method known to a person skilled in the art which makes it possible to obtain a dispersion of compounds in a thermoplastic composition can be used to prepare the composition according to the present invention.

A first process consists in mixing at least particles based on zirconium, titanium, cerium and/or silicon phosphate in the form of nanometric lamellar compounds with monomers and/or oligomers of a thermoplastic matrix, before or during the polymerization stage, and in subsequently polymerizing. The polymerization processes employed in the context of this embodiment are the usual processes. The polymerization can be interrupted at a moderate degree of progression and/or can be continued to the solid state by known post-condensation techniques.

Another process consists in mixing at least particles based on zirconium, titanium, cerium and/or silicon phosphate in the form of nanometric lamellar compounds with a thermoplastic matrix, in particular in the molten form, and in optionally subjecting the mixture to shearing, for example in an extrusion device, in order to produce a good dispersion. To do this, use may be made of a twin-screw extruder of ZSK30 type into which a polymer in the molten state and the nanometric lamellar compound according to the invention, for example in the powder form, are introduced. It is possible for said powder to comprise aggregates and/or agglomerates of particles according to the invention.

Another process consists in mixing a thermoplastic matrix, in particular in the molten form, and at least one composition, such as, for example, a concentrated mixture, comprising at least particles based on zirconium, titanium, cerium and/or silicon phosphate in the form of nanometric lamellar compounds and a thermoplastic matrix, it being possible for said composition to be prepared, for example, according to one of the processes described above.

There is no limitation on the form under which the nanometric lamellar compound can be introduced into the medium for the synthesis of the thermoplastic polymer or into a molten thermoplastic polymer. In the context of polyamide-based barrier materials, an advantageous embodiment consists in introducing, into the polymerization medium, a dispersion of the nanometric lamellar compound in water. In the context of polypropylene-based materials, an advantageous embodiment consists in mixing the polypropylene matrix, preferably in the molten state, with a powder formed of nanometric lamellar compound.

The nanometric lamellar compounds used in the process according to the invention can be nonintercalated and/or intercalated. In all cases, addition of an intercalation and/or exfoliation agent to the nanometric lamellar compound must not result in complete exfoliation of said nanometric lamellar compound, so as to obtain the composition according to the invention as defined above.

The invention also relates to articles obtained by forming the composition of the invention by any thermoplastic conversion technique, such as, for example, by extrusion, such as, for example, extrusion of sheets and films or extrusion blow-molding; by molding, such as, for example, compression molding, thermoforming molding or rotomolding; or by injection, such as, for example, by injection molding or by injection blow-molding.

The preferred articles of the invention are in particular components, films, sheets, pipes, hollow or solid bodies, bottles, conduits and/or tanks. These articles can be used in numerous fields, such as, for example, the automobile industry, such as conduits or tanks for fuels, injection sets, components coming into contact with gasolines, such as pump components, containers, packaging, such as, for example, packaging for solid or liquid foodstuffs, packaging for cosmetics, bottles and films. These articles can also be used for the packaging of starting materials, for example polyester-based thermosetting composites comprising glass fibers as fillers, for molding, bitumen sheets, or as protective or separating film during conversion operations, for example for vacuum molding.

The composition according to the present invention can be deposited or combined with another substrate, such as thermoplastic materials, for the manufacture of composite articles. This deposition or this combining can be carried out by the known methods for coextrusion, rolling, coating, overmolding, coinjection molding and multilayer injection blow-molding. Multilayer structures can be formed of one or more layers of materials according to the invention. These layers can be combined via coextrusion tie layers with one or more other layers of one or more thermoplastic polymers, for example polyethylene, polypropylene, poly(vinyl chloride) or poly(ethylene terephthalate).

The films or sheets thus obtained can be uniaxially or biaxially drawn according to the known techniques for the conversion of thermoplastics. The sheets or the panels can be cut up, thermoformed and/or pressed in order to give them the desired shape.

The term “and/or” includes the meanings “and”, “or” and all the other possible combinations of the elements connected to this term.

Other details or advantages of the invention will become more clearly apparent in the light of the examples given below solely by way of indication.

### Experimental Part

### EXAMPLE 1

Preparation of a Compound Based on Crystalline Zirconium Phosphate

The following reactants are used:
hydrochloric acid (36%, d =1.19),
phosphoric acid (85%, d =1.695),
deionized water,
zirconium oxychloride (in the powder form) at 32.8% as ZrO₂.
   Stage a): Precipitation

A 2.1 mol/l as ZrO₂ aqueous zirconium oxychloride solution is prepared beforehand.

The following are added at ambient temperature to a stirred 1 liter reactor:
Hydrochloric acid 50 ml
Phosphoric acid 50 ml
Deionized water 150 ml

After stirring the mixture, 140 ml of the 2.1 mol/l aqueous zirconium oxychloride solution are added continuously with a flow rate of 5.7 ml/min.

Stirring is maintained for 1 hour after the end of the addition of the zirconium oxychloride solution.

After removing the aqueous mother liquors, the precipitate is washed by centrifuging at 4500 revolutions/min with 1200 ml of 20 g/l H₃PO₄ and then with deionized water, until a conductivity of the supernatant of 6.5 mS is achieved. A cake based on zirconium phosphate is obtained.

Stage b): Crystallization

The cake is dispersed in 1 liter of 10M aqueous phosphoric acid solution and the dispersion thus obtained is transferred into a 2 liter reactor and then heated to 115° C. This temperature is maintained for 5 hours. The dispersion obtained is washed by centrifuging with deionized water until a conductivity for the supernatant of less than 1 mS is achieved. A cake based on crystalline zirconium phosphate is obtained. The cake resulting from the final centrifuging is redispersed in water, so as to obtain a solution giving a solids content in the region of 20%. The pH of the dispersion is between 1 and 2.

A dispersion of a crystalline compound based on zirconium phosphate is obtained, the characteristics of which are as follows:
Size and morphology of the particles: analysis using a Transmission Electron Microscope (TEM) demonstrates the production of a lamellar structure, the lamellae of which exhibit a size of between 100 and 200 nm. The particles are composed of a stack of substantially parallel lamellae, the thickness of the stacks along the direction perpendicular to the platelets being between 50 and 200 nm.
XRD analysis demonstrates the production of the crystalline phase Zr(HPO₄)₂.1H₂O (αZrP).
Solids content: 18.9% (by weight).
pH: 1.8.
Conductivity: 8 mS.

### EXAMPLE 2

Process for the Manufacture of αxZrP Intercalated by an Organic Base (Stage c))

The product resulting from example 1 is neutralized by addition of hexamethylenediamine (HMD): a 70% aqueous HMD solution is added to the dispersion until a pH of 5 is obtained. The dispersion thus obtained is homogenized using an Ultraturrax. The final solids content is adjusted by addition of deionized water (solids content: 15% by weight). The product obtained is referred to as ZrPi (HMD).

### EXAMPLE 3

Polyamide-based Material

A polyamide 6 having a viscosity number of 200 ml/g, measured in formic acid (Standard ISO EN 307), is synthesized from caprolactam according to a conventional process. This polyamide 6 is referred to as material A. The granules obtained are referred to as granules A.

A polyamide 6 having a viscosity number of 200 ml/g, measured in formic acid (Standard ISO EN 307), is also synthesized from caprolactam according to a conventional process while introducing, into the polymerization medium, an aqueous dispersion comprising either ZrPi (HMD) of example 2 or ZrP of example 1. Thus, 1% or 2% by weight of ZrP or ZrPi (HMD), with respect to the total weight of the polyamide, is introduced.

After polymerization, the various polymers are formed into granules. The granules B comprise ZrP of example 1. The granules C comprise ZrPi (HMD) of example 2. The granules are washed to remove the residual caprolactam. For this purpose, the granules are immersed in boiling water for two times 8 hours and are then dried under low vacuum (<0.5 mbar) at 110° C. for 16 hours.

Analysis by transmission electron microscopy of the granules B shows that the ZrP introduced during the polymerization of the polyamide remains in the form of a nanometric lamellar compound (lamellae) in the polyamide matrix. Exfoliation of the ZrP during the polymerization has therefore not occurred. The aspect ratio, calculated from the measurements of the thickness and of the length of the nanometric lamellar compounds, is 3.

Analysis by transmission electron microscopy of the granules C shows that the ZrPi (HMD) introduced during the polymerization of the polyamide results in the complete exfoliation of the ZrP in the form of individual ZrP lamellae in the polyamide matrix. The aspect ratio, calculated from the measurements of the thickness and of the length of the lamellae, is 250.

Test specimens are manufactured from the granules A, B or C. The test specimens have a width of 10 mm, a length of 80 mm and a thickness of 4 mm. The test specimens are conditioned at 28° C. and at 0% relative humidity.

Various tests were carried out on the test specimens according to the measurement methods indicated below in order to determine the mechanical properties of the materials:
Heat deflection temperature (HDT), measured according to Standard ISO 75, under a load of 1.81 N/mm².
Modulus, measured with the impact pendulum with a distance between supports of 60 mm, a hammer weight of 824 g (energy of 2 joules) and a starting angle of 160°.

The measurements carried out are presented in the table below.

TABLE 1

| | Impact | Heat deflection |
|---|---|---|
| Samples | modulus (MPa) | temperature (° C.) |
| Material A (PA 6) | 3852 | 58 |
| PA 6 + ZrPi (HMD) 1% | 4451 | 85 |
| PA 6 + ZrP 1% | 4670 | 87 |

The melt flow index is measured according to Standard ISO 133 after drying the polymer overnight at 110° C. under 0.267 mbar. The viscometer used is a Göttfert MPSE with a die of 2 mm. The MFI is expressed in g/10 min. The measurements are carried out at 275° C. with a load of 2160 g.

TABLE 2

| Compound | MFI |
|---|---|
| Material A (PA 6) | 27.7 |
| PA 6 + 2% ZrP | 23.5 |
| PA 6 + 2% ZrPi (HMD) | 12.2 |

### EXAMPLE 4

Preparation of Plastic Pipes

The granules A, B or C resulting from example 3 are formed by extrusion on a device of TR 35/24 GM type with the Mac.Gi trademark, the pipes produced having a thickness of 1 mm (external diameter of 8 mm; internal diameter of 6 mm), the diameters and the thicknesses of the pipes being measured before carrying out the permeability tests.

The pipes produced comprise 3 identical layers (internal, external and central layer).

The characteristics of the processing are as follows (the values are given respectively for the internal, external and central layers):
temperature of the extruder: 230/230/230° C.,
screw speed: 8/9/3 rpm,
motor torque: 4.7/3.8/4.6 amperes,
extrusion outlet pressure: 2000/1900/2200 psi (pounds per square inch),
vacuum: −0.2 bar.

The pipes are subsequently stored at 23° C. and 0% RH (relative humidity) for 48 h.

The tensile strength is measured on an Instron 4500 (100 kN load cell), pull rate: 50 mm/min, initial separation of the jaws: 40 mm. The measurements are calculated on the basis of the load divided by the circular area of the pipe over an average of 5 samples.

The mechanical measurements are mentioned in the following table:

TABLE 3

| | Tensile strength |
|---|---|
| Samples | (N/mm²) |
| Material A (PA 6) | 49 |
| PA 6 + ZrPi (HMD) 2% | 61 |
| PA 6 + ZrP 2% | 85 |

### EXAMPLE 5

Permeability to M15 Gasoline and to Lead-free Gasoline

The permeability of the various materials to M15 gasoline was evaluated by measuring the loss in weight as a function of the time. The various pipes of example 4 are dried in an oven under vacuum at 70° C. for 12 hours. The various pipes are filled with M15 gasoline or lead-free gasoline and the said pipes are stoppered. The pipes, thus filled, are weighed on a precision balance. The pipes are subsequently placed in an oven at 40° C. for 45 days. The pipes are weighed at regular time intervals and the loss in weight is recorded. The permeability is thus measured under static conditions.

The M15 gasoline is composed, by volume, of: 15% methanol, 42.5% toluene and 42.5% isooctane (2,2,4-trimethylpentane).

The curve of loss in weight as a function of the time breaks down into two phases: a first induction phase (corresponding to the diffusion of the fluid through the wall of the pipe) and then a second phase of reduction in the weight of the pipes (corresponding to the passage of one or more fluids through the wall of the pipe). The permeability, measured in g.mm/m²/day, is calculated from the slope of the second phase.

With the M15 gasoline, it is observed, over time, that the pipes are first permeable to the methanol (the methanol passes first through the walls of the pipes); and subsequently permeable to the toluene +isooctane mixture (which subsequently passes through the walls of the pipes).

TABLE 4

| | | Toluene + | Lead-free |
|---|---|---|---|
| | Methanol | isooctane | gasoline |
| Compounds | permeability | permeability | permeability |
| Material A (PA 6) | 92 | 5.4 | 0.6 |
| PA 6 + 1% ZrP | 34 | 2.28 | 0.27 |

### EXAMPLE 6

Barrier Film Comprising Zirconium Phosphate

The polymer granules resulting from example 3 are formed by extrusion on a device with the CMP trademark.

The characteristics of the processing are as follows:
temperature of the extruder: between 260 and 290° C.,
screw speed: 36 rpm,
motor torque: 8-10 amperes,
variable draw rate (film thicknesses between 50 and 70 μm).

Several films were obtained having a thickness of 50 to 70 μm.

The films are conditioned at 23° C. for 48 hours, the RH (relative humidity) ranging from 0% to 90%, before being subjected to the determination of their permeability to oxygen, carbon dioxide and water according to the procedures described below:

Permeability to Oxygen:

The oxygen transmission coefficient is measured according to Standard ASTM D3985 under the following specific conditions.

Measurement Conditions:

Temperature: 23° C.,
Humidity: 0%, 50% or 90% RH,
Measurements with 100% oxygen on 3 test specimens of 0.5 dm²,
Stabilization time: 24 h,
Measurement device: Oxtran 2/20.
   Permeability to Carbon Dioxide:

Measurement of the carbon dioxide transmission coefficient according to the document ISO DIS 15105-2 Annex B (chromatographic detection method).

Measurement Conditions:

Temperature: 23° C.,
Humidity: 0% RH,
Measurements on 3 test specimens of 0.5 dm²,
Stabilization time: 48 h,
Measurement device: Oxtran 2/20.
   Chromatographic Conditions:
Oven: 40° C.,
Columns: Porapak Q,
Flame ionization detection, the detector being preceded by a methanization oven.

Calibration of the chromatograph with standard gases with a known concentration of carbon dioxide.

Permeability to Water Vapor:

Determination of the water vapor transmission coefficient according to Standard NF H 00044 (Lyssy device).

Measurement Conditions:

Temperature: 38° C.,
Humidity: 90% RH,
Measurements on 3 test specimens of 0.5 dm².

Calibration with reference films having a graded permeability of 26.5, 14 and 2.1 g/m².24 h.

TABLE 5

| | Material A | PA 6 + 2% | PA 6 + 2% |
|---|---|---|---|
| Compounds | (PA 6) | ZrP | ZrPi (HMD) |
| O₂ Permeability - 0% RH | 0.96 | 0.2 | 0.23 |
| (cm³ · mm/m² · 24 h · bar) | | | |
| O₂ Permeability - 50% RH | 0.6 | 0.17 | 0.24 |
| (cm³ · mm/m² · 24 h · bar) | | | |
| O₂ Permeability - 90% RH | 1.59 | 0.55 | 0.80 |
| (cm³ · mm/m² · 24 h · bar) | | | |
| CO₂ Permeability - 0% RH | 4.18 | 0.57 | 0.98 |
| (cm³ · mm/m² · 24 h · bar) | | | |
| H₂O Permeability - 90% RH | 8.31 | 4.07 | 5.85 |
| (g · mm/m² · 24 h · bar) | | | |

### EXAMPLE 7

Process for the Manufacture of αZrP Powder

αZrP is prepared as mentioned in example 1, apart from the fact that, during the crystallization stage of stage b), the cake is dispersed in 1 liter of a 12.6M aqueous phosphoric acid solution, the dispersion thus obtained being transferred into a 2 liter reactor and then heated to 1250C. The other stages of the process are retained.

An αZrP similar to that of example 1 is thus obtained, with, however, a lamellar structure being obtained for which the lamellae exhibit a size of between 300 and 500 nm.

The dispersion is subsequently dried in an oven at 90° C. for 15 h. The dry product is thus a powder referred to as ZrP.

### EXAMPLE 8

Process for the Manufacture of a Powder Formed of αZrP Treated with an Aminosilane

The dispersion before drying of example 7 is treated by addition of 3-aminopropyltriethoxysilane (aminosilane): the aminosilane is added to the dispersion until the protons have been completely neutralized (N/P=1). The dispersion thus obtained is washed, to remove the residual alcohol, and is then dried in an oven at 90° C. for 15 h. The product thus obtained is referred to as ZrP/aminosilane.

### EXAMPLE 9

Material Based on a Polypropylene Homopolymer Resin

A nanocomposite based on polypropylene (PP) and on ZrP of example 7 or example 8 is prepared under the following conditions: A mixture comprising 96.8% of isotactic polypropylene homopolymer resin as granules with a melt flow index (according to Standard ISO 1133) of 3 g/10 min at 230° C. under a load of 2.16 kg, 3% of inorganic filler, dried in an oven at 90° C. for 16 h, and 0.2% of Irganox B225 antioxidant is prepared in a Brabender mixer equipped with W50 rotors with a rotational speed of the rotors of 125 rpm, a filling coefficient of 0.7 and a trough temperature of 150° C., for a time of 5 min. The mixtures thus obtained are thermoformed in a press at 200° C. for 10 minutes under a pressure of 200 bar and are then cooled at 15° C. for 4 minutes at 200 bar to form plaques of 100 mm by 100 mm by 4 mm. Test specimens with dimensions of 80 mm by 10 mm by 4 mm are subsequently cut out.

Analysis by transmission electron microscopy of the test specimens shows that the ZrP and the ZrP/aminosilane introduced into the polypropylene remains in the form of a nanometric lamellar compound (lamellae) with an aspect ratio of less than 100.

These test specimens are characterized by three-point bending according to Standard ISO 178 and by notched Charpy impact according to Standard ISO 179.

The test conditions used are as follows:
Three-point bending: 5 test specimens with ISO dimensions tested at 23° C. under the conditions drawn up by Standard ISO 178.
Notched Charpy impact: 5 test specimens with ISO dimensions notched using a blade cut at 45° and having a radius of curvature of 0.25 mm are tested at 23° C. under the conditions drawn up by Standard ISO 179.
Density: calculated from the densities of the various components.

In this example, the virgin polypropylene resin was processed and evaluated under the same conditions as the filler-comprising resins. The measurements carried out are presented in the table below:

TABLE 6

| | | Flexural | Notched impact |
|---|---|---|---|
| Sample | Density | modulus (GPa) | strength (kJ/m²) |
| PP homopolymer | 0.92 | 1.37 | 4.6 |
| PP + talc 20% | 1.06 | 2.43 | 3 |
| PP + ZrP | 0.94 | 1.35 | 6.7 |
| (example 7) 3% | | | |
| PP + ZrP/aminosilane | 0.94 | 1.53 | 5.5 |
| (example 8) 3% | | | |

An enhancement in the mechanical properties, in particular the modulus and/or the impact strength, is thus observed with the polypropylene comprising ZrP as filler of the invention exhibiting a similar density to the filler-free polypropylene. Moreover, it is apparent that the polypropylenes comprising ZrP as fillers of the invention exhibit enhanced properties of resistance to scratching and strains at break under tension, with respect to the virgin polypropylene resin processed and evaluated under the same conditions.

1-20. (canceled)

21. A composition comprising at least one thermoplastic matrix and particles based on zirconium, titanium, cerium and/or silicon phosphate, wherein at least 50% by number of the particles are in the form of nanometric lamellar compounds exhibiting an aspect ratio of less than or equal to 100.

22. The composition as claimed in claim 21, wherein the particles of nanometric lamellar compounds exhibit an aspect ratio of less than or equal to 50.

23. The composition as claimed in 21, wherein the particles of nanometric lamellar compounds exhibit an aspect ratio of less than or equal to 10.

24. The composition as claimed in claim 21, wherein at least 80% by number of the particles are in the form of nanometric lamellar compounds exhibiting an aspect ratio of less than or equal to 100.

25. The composition as claimed in claim 24, wherein 100% by number of the particles are in the form of nanometric lamellar compounds exhibiting an aspect ratio of less than or equal to 100.

26. The composition as claimed in claim 21, comprising from 0.01 to 30% by weight of particles with respect to the total weight of the composition.

27. The composition as claimed in claim 26, comprising from 0.1 to 5% by weight of particles with respect to the total weight of the composition.

28. The composition as claimed in claim 21, wherein the nanometric lamellar compound is based on zirconium phosphate.

29. The composition as claimed in claim 21, further comprising particles in the form of nanometric lamellar compounds having an intercalation, and/or exfoliation agent.

30. The composition as claimed in claim 21, wherein the thermoplastic matrix is composed of at least one thermoplastic polymer chosen from the group consisting of: polyamides, polyesters, polyolefins, poly(arylene oxide)s, and the blends and copolymers based on these (co)polymers.

31. The composition as claimed in claim 21, wherein the thermoplastic matrix is a polyamide chosen from the group consisting of: polyamides 6, polyamides 66, polyamides 11, polyamides 12, poly(meta-xylylenediamine)s, the blends and copolymers based on these polyamides.

32. The composition as claimed in claim 21, wherein the thermoplastic matrix is a polyolefin chosen from the group consisting of: polyethylene, polypropylene, polyisobutylene and polymethylpentene, their blends and copolymers.

33. The process for the manufacture of a composition as defined in claim 21 comprising the steps of:
a) mixing the particles based on zirconium, titanium, cerium and/or silicon phosphate in the form of nanometric lamellar compounds with monomers and/or oligomers of a thermoplastic matrix, before or during the polymerization stage, and
b) polymerizing the thermoplastic matrix.

34. A process for the manufacture of a composition as defined in claim 21, comprising the steps of mixing the particles based on zirconium, titanium, cerium and/or silicon phosphate in the form of nanometric lamellar compounds and a thermoplastic matrix.

35. The process for the manufacture of a composition as defined in claim 21, comprising the step of mixing the thermoplastic matrix and one composition comprising at least particles based on zirconium, titanium, cerium and/or silicon phosphate in the form of nanometric lamellar compounds and a thermoplastic matrix.

36. The process as claimed in claim 33, wherein the particles based on zirconium, titanium, cerium and/or silicon phosphate in the form of nanometric lamellar compounds exhibit an aspect ratio of less than or equal to 100.

37. The process as claimed in claim 33, wherein the particles based on zirconium, titanium, cerium and/or silicon phosphate in the form of nanometric lamellar compounds are intercalated and/or nonintercalated.

38. An article, obtained by forming a composition as defined in claim 21.

39. The article as claimed in claim 38, being a film, a sheet, a pipe, a hollow or solid body, a bottle, a conduit or a tank.
